(19) United States
(12) Patent Application Publication
(10) Pub. No.: US 2007/0215182 A1
(43) Pub. Date: Sep. 20, 2007

(54) Process for washing the interior of containers made of plastic material

(75) Inventor: Spotti Giovanni, Fidenza (Parma) (IT)

Correspondence Address: ARENT FOX PLLC, 1050 CONNECTICUT AVENUE, N.W., SUITE 400, WASHINGTON, DC, 20036, US

(73) Assignee: R.BARDI S.R.L.

(21) Appl. No.: 11/797,953

(22) Filed: May 9, 2007

Related U.S. Application Data
(62) Division of application No. 10/509,676, filed on Oct. 8, 2004.

(30) Foreign Application Priority Data
Apr. 10, 2002 (IT) PR2002A000016

(51) Int. Cl. B08B 9/00; B08B 3/00

(52) U.S. Cl. 134/22.1; 134/34

(57) ABSTRACT

Process for washing containers (1) made of plastic material with capacity ranging between 5 and 30 litres which may be provided with a handle (7) to facilitate handling, comprises: gripping the container (1) in upside down condition, i.e. with a mouth (9) oriented downwards, spraying suitable cleaning liquid inside the container (1) through movable nozzles (4) producing at least a pair of rotating jets of cleaning fluid which simultaneously penetrate inside the container (1) through the mouth (9) to clean the interior of the container (1), wherein the container (1) rotates about its own central longitudinal axis during the spraying phases and the jets of cleaning fluid are parallel and clean the interior of the container and of the handle (7). Each initial or terminal phase of the rotary motion the jets of cleaning fluid internally cleans the handle (7) of the container (1).

### TECHNICAL FIELD AND BACKGROUND ART

The present invention relates to a process for washing the interior of containers made of plastic material.

In particular the present invention pertains to the sector of linear washer machines used for instance for cleaning reusable containers such as large sized tanks, i.e. large bottles, containing about 11, 19 or 23 litres (i.e. 3, 5, 6 gallons), generally applied on water dispensing apparatuses.

The Italian patent application for industrial invention no. PR2000A000006 in the name of the same Applicant discloses a machine for washing containers comprising a base structure, means for housing the containers positioned with their mouth oriented downwards, a plurality of brushes mounted able to rotate on the base structure to clean the outer surface of the containers. In this machine the means for housing the containers comprise gripping organs able to move between an open position and a closed position and provided with sliding elements, interposed between the gripping organs and the neck of the container and constituted by idle rollers, to allow the rotation of the container by means of the rotating action of the brushes.

Cleaning the interior of the container is particularly difficult, especially if the container is provided with a grip handle, which must be cleaned internally together with the container.

In PR2000A000006, the base structure of the washer machine has a plurality of nozzles which generate a jet able to move according to an arching trajectory, which penetrates inside the containers to wash the internal surfaces and which partially cleans the external surface in proximity to the neck. However, although numerous nozzles are present, each container is cleaned by means of a single jet of cleaning fluid emitted by a single nozzle. This is also confirmed by the description of the aforesaid document which repeatedly states “ . . . the internal washing operation takes place when the mouth of the container lies above a nozzle” and “ . . . the nozzle follows the container.”

According to some possible embodiments, the nozzles can be fixed or movable relative to the base structure.

In the first case, the motion of the containers along the base structure is intermitted and the interior is washed when the mouth of the containers lies above a nozzle.

In the second case, the motion of the containers and the washing of their interior is continuous because the nozzle follows the container.

The presence of a single nozzle, fixed or movable, is not always sufficient for an adequate cleaning of the interior of the container, above all if the handle is presence.

In a spraying device for bottle cleaning machines DE-A-4330335 discloses at least two spraying jets simultaneously directed by a nozzle arrangement into a bottle, which jets converge over their entire surfaces inside the bottle to form an acute angle and as a result are deflected and scattered. This causes the entire interior of the bottle to be sprayed and sprinkled which results in intensive cleaning even in the case of bottles with surfaces which are particularly water-repellent, for example polyethene bottles.

However the above constitutes also the main drawback of the apparatus because when the two jets intersect each other inside the bottle they cause a nebulization of the liquid with a loss of cleaning power with respect to two parallel jets.

Another drawback is the fact that the two jets are associated to two cleaning stations duplicating the components.

### DISCLOSURE OF THE INVENTION

The aim of the present invention is to eliminate the aforesaid drawbacks and to make available a simple and economical washing process, which can provide for an adequate internal washing of the container and possibly also of the related handle.

Said aims are fully achieved by the washing process of the present invention, which is characterised by the content of the claims set out below.

### BEST MODE FOR CARRYING OUT OF THE INVENTION

This and other characteristics shall become more readily apparent from the following description of a preferred embodiment illustrated, purely by way of non limiting example, in the accompanying drawing tables, in which:

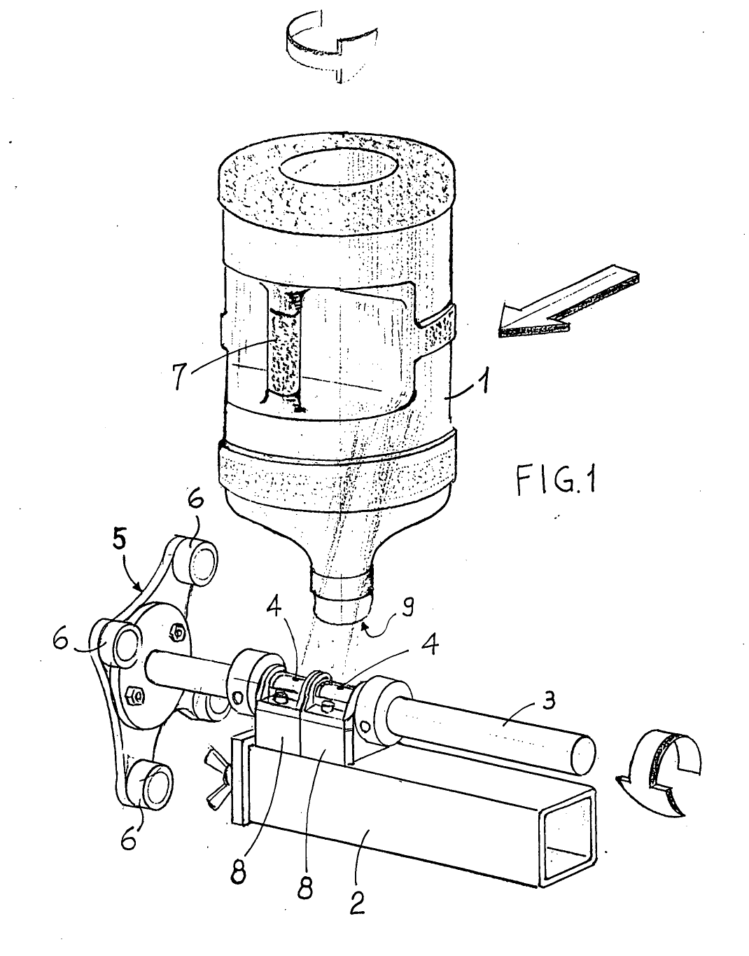

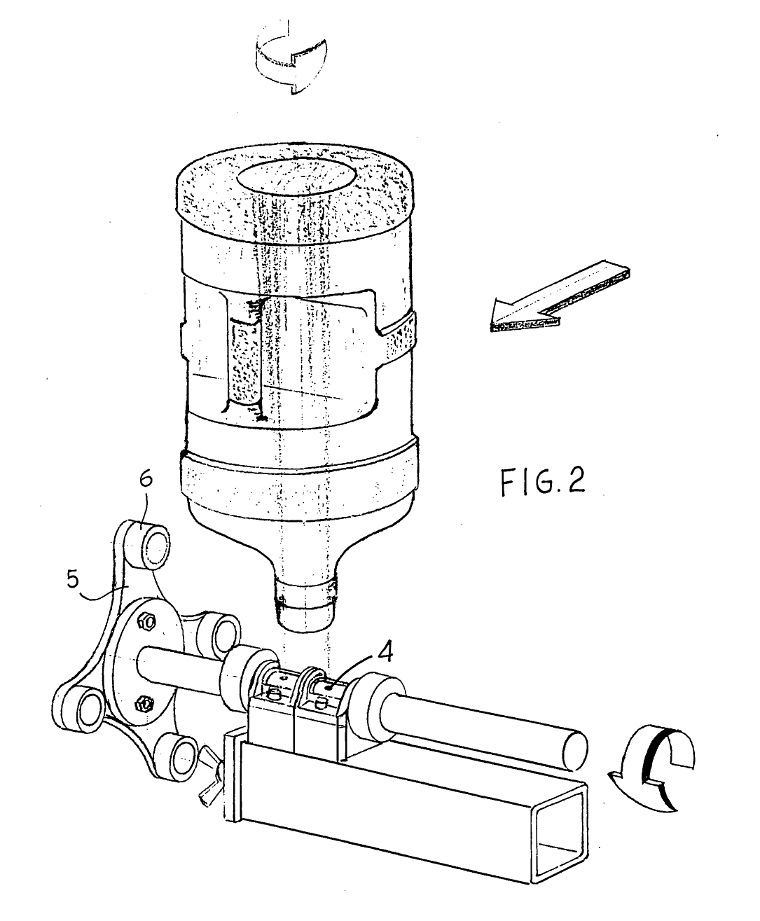

FIGS. 1 through 3 show three successive operative steps of the washing process.

With reference to the figures, the number 1 designates a container or large bottle destined to be introduced in a washer machine, preferably of the linear type.

The container 1 is generally of the reusable type such as water tanks having a capacity ranging between 5 and 30 litres, used in dispensing devices and destined to undergo a cleaning operation both of their interior and of their exterior walls.

For the description of the washer machine and of the means for gripping and handling the container 1, reference is made to the content of the aforementioned patent application PR2000A000006, since substantially the same means are used, which for the sake of greater clarity are not shown in the figures (such as the gripping means, the brushes, the rollers and the support structure), where instead only the washer apparatus and the bare container are shown.

The reference number 2 indicates a fixed frame whereto is anchored, free to rotate on itself, a rigid conduit 3 for feeding a cleaning fluid.

The conduit 3 has on its lateral surface two series of four nozzles 4 each, arranged at 90 from each other on the circumference of the conduit.

To the conduit 3 is made integral a star-shaped element 5 provided with four idle rollers 6.

There can also be more than two series of nozzles and each series can comprise a different number of nozzles, however the number of nozzles 4 of each series is equal to the number of idle rollers 6 present on the star-shaped element 5.

The container 1 is provided in the illustrated case with a handle 7, but the invention also applies to containers 1 without a handle.

The operation of the apparatus is as follows. When the container 1, supported in known fashion by gripping means associated with a support structure or movable bar, it approaches the washing apparatus rotating about its own longitudinal axis, the support structure or movable bar impacts against one of the idle rollers 6 producing the rotation of the star-shaped element of about 90 and hence the consequent counter-clockwise rotation of the conduit 3 in such a way that the pair of “free” nozzles 4 (i.e. not belonging to the area of the conduit that is laterally sealed by protection elements 8) can emit jets of fluids which simultaneously penetrate inside the container 1 through the mouth 9 describing a circular sector.

The nozzles 4 constitute means for spraying fluid inside the container and are destined to effect a complete interior cleaning of the container as well as an exterior cleaning action in the area of the mouth 9.

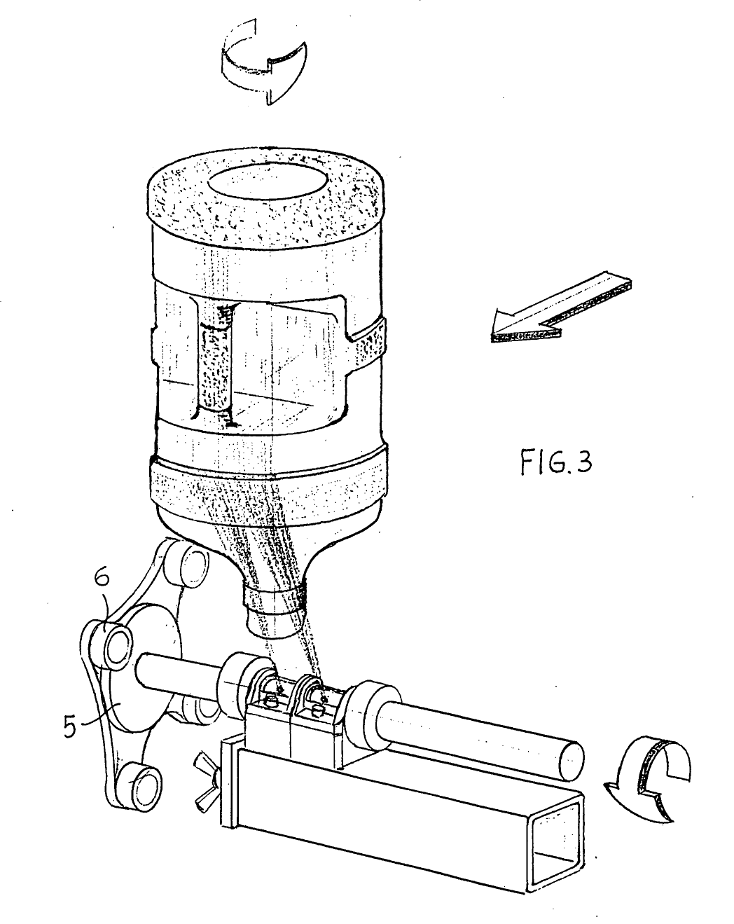

In particular, in a terminal phase of the rotating movement (illustrated in FIG. 3) or in an initial phase (in an embodiment not illustrated herein which provides for the clockwise movement of the conduit 3) the two jets clean the internal lateral surface of the container and the internal cleaning of the handle 7, whilst the intermediate phase is oriented for the cleaning of the bottom of the container.

Actually, the orientation of the container is unknown, in the sense that the position of the handle is not known. For this reason, during the action of the jets the container is set in rotation on itself by the brushes (see patent application PR2000A000006) in such a way that the jets are able to impact also on the area of the handle, wherever it is located at the time of the start of the washing cycle.

The rotation of the container causes the whole internal surface of the container to be accurately cleaned by the two jets.

The simultaneous presence in the container of at least two distinct jets coming from respective distinct nozzles, allows a better cleaning operation than what was possible with the prior art that provided for a single jet.

1. A process for washing the interior of containers (1) made of plastic material with a capacity ranging between 5 and 30 litres and provided with a handle (7) to facilitate their handling, of the type comprising the following phase:
gripping the container (1) in upside down condition, i.e. with a mouth (9) oriented downwards,
spraying suitable cleaning liquid inside the container (1) through movable nozzles (4) producing at least a pair of rotating jets of cleaning fluid which simultaneously penetrate inside the container (1) through the mouth (9) to clean the interior of the container (1),
characterised in that the container (1) rotates about its own central longitudinal axis during the spraying phases and the jets of cleaning fluid are parallel and clean the interior of the container and of the handle (7).

2. A process as in claim 1 wherein in each initial or terminal phase of the rotary motion the jets of cleaning fluid internally clean the handle (7) of the container (1).
